(19) United States
(12) Patent Application Publication
(10) Pub. No.: US 2007/0067348 A1
(43) Pub. Date: Mar. 22, 2007

(54) Repeated Segment Manager

(76) Inventor: Dmitriy S. Andreyev, Newton, MA (US)

Correspondence Address: Dmitriy Andreyev;#135, 144 Quincy Shore Dr., Quincy, MA, 02171, US

(21) Appl. No.: 11/532,683

(22) Filed: Sep. 18, 2006

Related U.S. Application Data
(60) Provisional application No. 60/596,345, filed on Sep. 18, 2005.

(51) Int. Cl. G06F 17/00

(52) U.S. Cl. 707/104.1

(57) ABSTRACT

The present invention provides a repeated segment manager for identifying and updating the repeated data segments. The repeated segment manager uses a search engine for automatically identifying the plurality of repeated data segments within one or more documents. The information described the identified repeated data segments is recorded in the search results database. The present invention also provides a UI processor that delivers the repeated segment information to the user in the form of the UI changes or a source file changes.

### CROSS-REFERENCE TO RELATED ACTIONS

This application claims the benefits of U.S. Provisional Application No. 60/596345 filed Sep. 18, 2005.

### BACKGROUND

Electronic documents frequently contain repeated information. The repeated information may appear in multiple locations within a document or a collection of documents. Determining that a particular segment of information is repeated can significantly speed up the review process as well as reduce the document composition time. A user who knows with certainly that the repeated information is, indeed, “repeated” and has already been reviewed can simply skip the repeated segment. The authors and editors do not need to retype the repeated paragraphs or pages of data, and, instead, can copy and paste the information multiple times.

Unfortunately, prior to this invention, the readers of electronic documents has very limited ways of automatically identifying the repeated data segments. Users of popular document editing systems could suspect that a particular segment of data has already been reviewed, but, if the segment of data is larger then a few words, sentences or paragraphs, could not know with certainty that the repeated segment did not carry any new information or was, in fact, “repeated.”

The known electronic document systems could potentially identify the repeated data segments with certainty using the “search” function. The search function, however, required users to specify a particular search term. Also, the search function was designed to identify fairly short segments of data that could not be used for long segments of information, could not include pictures, sounds or other objects inserted within the documents.

The known electronic document Systems also provided little or no support to editors of electronic documents that used the repeated data segments in their documents. For example, if the contents of the repeated data segment had to be updated, the user had to make the change in every repeated instance.

For large documents, the manual updating of the repeated data segments was problematic because the users could simply forget about specific instances of the repeated information. Accordingly, there is a need to provide a method and apparatus for automatically identifying and updating the repeated data segments.

### SUMMARY

In accordance with implementations of the invention, one or more of the following capabilities may be provided.

The present invention provides a method and apparatus for identifying the repeated data segments within one or more documents. The present invention also provides a method and an apparatus for updating the repeated segments. The present invention also provides a method and apparatus for storing the repeated segment information in the search result database and delivering the search results to the user.

These and other capabilities of the invention, along with the invention itself, will be more fully understood after a review of the following figures, detailed description, and claims.

### BRIEF DESCRIPTION OF THE FIGURES

FIG. 1 shows one embodiment of the repeated data segment manager.

FIG. 2 shows one embodiment of the configuration dialog for configuring the repeated data segment manager.

### DETAILED DESCRIPTION OF PREFERRED EMBODIMENTS

Embodiments of the present invention provide techniques for identifying all updating the repeated data segments. This description is exemplary, however, and not limiting of the invention as other implementations in accordance with the disclosure are possible.

One embodiment of the present invention can detect and update the repeated data segments. A repeated data segment can be represented by a collection of data such as characters, words, pictures or any other data that may be stored in the electronic documents. For example, if the collection of data appears multiple times within the same document or, a set of documents, then this collection of data can represent a repeated data segment for the purposes of this invention.

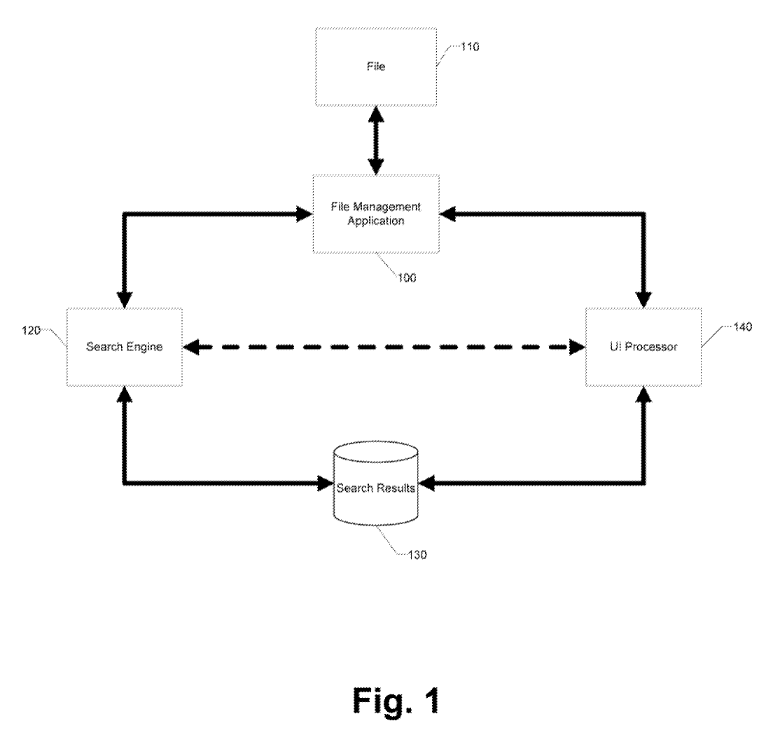

FIG. 1 shows one embodiment of the present invention. In this embodiment, the File Management Application (FMA) 100 manages the File 110. The. FMA 100 is integrated with the Search Engine (SE) 120. The SE 120 is designed for identifying the repeated data segments within electronic documents managed by the FMA 100. The SE 120 uses the application programming interface (API) provided by the FMA 100 manufacturer to access the contents of the File 110 and identify the repeated segments.

The information identifying the repeated data segments, in one embodiment, can be stored in the Search Results database 130. In another embodiment, the SE 120 forwards the information identifying the repeated data segments directly to the UI Processor 140.

The UI Processor 140 receives the information identifying the repeated data segments either front UI Processor 140 or from the Search Results database 130 and delivers the search results to the user in the form of the user interface notification or a file change.

In one embodiment, the File Management Application 100 can be a commercially available application, such as Microsoft Word. Microsoft Corporation provides a set of application programming interfaces (APIs) designed for integrating the external applications with the Microsoft Word. These APIs allow external applications to access the content of Microsoft Word documents as well as receive events indicating the current state of the user.

The current state of the user, for example, can indicate that a user has selected a particular command from the menu or that the user has modified the document. The Microsoft Word APIs allow external applications to modify Microsoft Word documents and make changes to the Microsoft Word's user interface.

Importantly, the present invention is not limited to any particular file management application, such as Microsoft Word. The functionality provided by the present invention can be developed for multiple FMAs, including, but not limited to Microsoft Office applications, Adobe Acrobat and Google web-based document editing applications.

Furthermore, the present invention can be implemented by the FMA manufacturer itself, with or without the help of the publicly exposed APIs. For example, the FMA 100, the SE 120, the UI processor 140 can all be implemented in a single executable, as a part of the same application.

Using the API provided by the FMA manufacturer, the Search Engine 120 can be integrated with the FMA 100, such that it can receive the instructions from the FMA and also send the instruction to the FMA 100. The example of the command received from the FMA 100 can be an instruction to identify the repeated segments within the specific File 110. In that instruction, the File 110 can be identified, for example, by the file name or by a pointer to the software object initialized to control a specific document. Using the received document information, the SE 120 can access the contents of the File 110.

The example of the command that SE 120 can send to the FMA 100 is an instruction to highlight in yellow a particular data segment within the document. This instruction, for example, can identify the document and specify an action to be performed on a particular part of the document.

In one embodiment, when the SE 120 receives the instruction to identify the repeated segments within a specific document, it uses one or more software searching algorithms. The current invention is not limited to any specific searching algorithm.

In some cases the present invention can be implemented using a well-known sequential search algorithm. Even though the sequential search algorithm may run inefficiently, the search times may be acceptable especially if the searching is done during the “off-time,” while the user is not immediately expecting the results. The off-time searching is sometimes referred to as the “batch mode” searching.

Other embodiments of the present invention may use more advanced pattern searching algorithms. The following is a sample list of searching algorithms that can be used for the purposes of this invention.
Naïve string search algorithm
Rabin-Karp string search algorithm
Knuth-Morris-Pratt algorithm
Boyer-Moore string search algorithm
Bitap algorithm (shift-or, shift-and, Baeza-Yates-Gonnet)

Some of the most efficient string searching algorithms are based on the preprocessing of the searched information. As a result of the preprocessing, these search algorithms, in some instances, generate an index. For example, after creating an index, the preprocessing algorithms can find the patterns quickly by using the binary search.

The problem with identifying all repeated data sections within a single document or a collection of documents is that most documents contain repeated data segments that are of little or no interest for readers. For example, identical words may appear multiple times within a document or a set of documents. Identifying these repeated single words may not significantly reduce the review process.

In one embodiment, the present invention provides ways to configure the parameters of the repeated data segment. The users of the present invention can identify the minimum length of the segment by specifying the number of characters, words, bytes, or any other threshold describing a collection of data.

Furthermore, the present invention provides ways to define a scope for the segment identification. The scope may, for example, be a page, range of pages, the whole document, multiple documents in a particular location, multiple documents in multiple locations, etc. Besides the scope and the length of thee minimum repeated data segments, there are other useful parameters that are described further in this document.

In one embodiment, the SE 120 generates a list of all possible continuous data segments of a specified length, equal to the minimum threshold configured by the user or selected by default. The SE 120 searches the contents of the entire document for repeated instances of each of the identified segments. The search can be performed using any of the search algorithms described hereinabove.

In one embodiment, when the SE 120 finds a repeated instance of the segment, it determines the true boundaries of the repeated segments. The true boundaries, in this embodiment need to be determined because the engine may search only for the repetitious blocks of the minimum length. In one embodiment, the true boundaries are determined by comparing the information located before the starting point of the searched segment and after the ending point of the searched segment.

In one embodiment, the search for the segment within the file can be implemented using the fault tolerance level or the error threshold specified by the user. In this embodiment, the compared data segments do not need to be exactly similar. Instead they may be different to the extent allowed by the fault tolerance level. The allowable differences between the repeated data segments will be referred to as “delta” within the body of this document.

After the Search Engine 120 identifies the repeated data segments, in one embodiment, it records the repeated segment information in the Search Results database 130. The repeated segment information recorded in the Search Results database 130 can include the name or ID of the document where the segment is located, the location of the repeated data segment within the document and the length of the repeated data segment.

In one embodiment of the present invention, the Search Results database 130 need not be implemented as a persistent storage of data. For example, the Search Results database 130 may be represented by a data structure that holds the information temporarily. In one embodiment that data stored in this data structure can be lost if user closes the file or exits from the application.

In one embodiment, the repeated segment information stored in the Search Results database 130 also includes the information identifying the delta within the repeated data segments. The delta may represent a single continuous collection of data or multiple instances that appear within the repeated data segment.

For example, if the minimum threshold is 20 characters, and the error threshold is 5 characters, the delta may represent a collection of 5 characters that appear in 1st, 10th, 12th, 15th, and 17th position within the data segment. Alternatively, all 5 different characters may continuously appear, for example, starting from the 5^{th} position and ending in the 9^{th} position of the repeated data segment.

To identify the delta, in one embodiment, the database has a special table that stores the repeated data segment ID, the beginning location of the delta within the repeated data segment and the ending location of the delta within the repeated data segment. The database configured in this way can store multiple instances of the delta within the single repeated data segment. It can also store multiple instance of the delta for multiple data segments.

The UI Processor 140 receives the information identifying the repeated data segments within the File 110 either from the Search Results database 130 or from the SE 120. In one embodiment, the UI Processor 140 uses this information to update the user interface and deliver the repeated data segment information to the user of the FMA 100.

For example, the UI Processor 140 may determine that a document 100 that is currently displayed to the user has 2 repeated data segments: one that appears at the beginning of the 4^{th} page of the document and another one that appears at the end of the 40^{th} page of the document.

The UI Processor 140 can deliver this information to the user, for example, by highlighting the repeated data segments on the 4^{th} page and on the 40^{th} page of the document. The UI Processor 140 can also deliver the identified repeated segment information to the user of the FMA 100 using the user's preferences selected in the Repeated Segment Manager's configuration dialog.

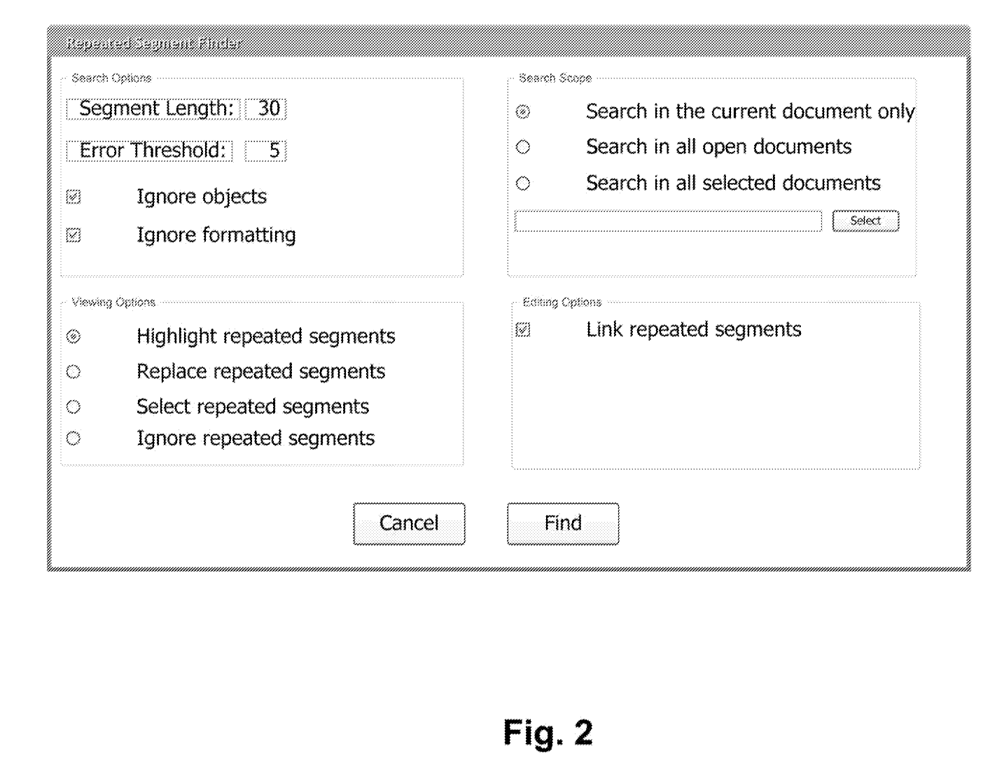

FIG. 2 shows one embodiment of the configuration dialog that can be used to configure the repeated segment manager application. This dialog, in one example, can be implemented in the form of the ActiveX control and embedded in the existing FMA application. In another embodiment, this dialog can be implemented as a portion of the FMA by the FMS's manufacturer and simply added to the “Tools” menu of the FMA.

One of the parameters in the Repeated Segment Finder configuration dialog is called “Segment Length.” This parameter can define the minimum length of the repeated segment that the user wants to be identified.

As explained hereinabove, the repeated segments of short lengths may not be very helpful to users. For example, the word “the” may appear thousands of times within the body of the large document. The knowledge of this fact does not really help the person who creates the document, or the person who reads it.

For example, if the user specifies the minimum length of the repeated date segment to be 30 characters long, then words like “the” and “a” will simply be ignored. The engine will only consider sequences of characters of 30 characters or more.

Another option that, in one embodiment can be configured using the Repeated Segment Finder dialog is called the “Error Threshold.” This option allows users to specify a maximum number of units of data that may not match from one repeated segment to another.

For example if the Error Threshold is 5 characters and the segment length is 30 characters, then, in one embodiment the Search Engine 120 will determine that two segments are “repeated,” even though 5 characters within the two segments are not identical.

In another embodiment if the Error Threshold is 5 characters and the segment length is 30 characters, the Search Engine 120 may only compare 30−5=25 characters for any two segments. This choice may speed up the repeated segment discovery process.

Another option that may appear in the Repeated Segment Finder dialog is called the “Ignore Objects.” This option may be useful in the FMA applications that allow insertions of the pictures and sounds directly in the body of the text documents.

In one embodiment, if the “Ignore Objects” option is selected, the search engine may simply skip the inserted objects within the body of the text as if they do not even exist there. This option may be helpful because, for example, the comparison of the media objects can be difficult and time consuming.

If the “Ignore Objects” option is not selected, then the system may try to compare the object information based on the object's metadata. The metadata information may include the file name, file size, the creation date, the modification date, the author, etc. However the comparison based on the metadata in some embodiments may not be exact.

In another embodiment, if the “Ignore Objects” option is not selected, the system may use the external application to find out whether the objects are identical or not. The external applications may be specifically designed to compare media files, such as sounds, pictures or video clips.

Another option that may appear in the Repeated Segment Finder dialog is called the “Ignore Formatting.” This option may be useful in the modern FMA applications that support advanced formatting such as tables and fonts.

If the “Ignore Formatting” option is selected, the SE 120 will simply ignore the formatting information that can be possibly associated with the data. For example if one repeated segment appears in a table cell and another repeated segment does not, the SE 120 will simply ignore this fact. If this option is not selected, then, in some embodiments of the present invention, the SE 120 may treat these segments as not repeated.

Another option that may appear in the Repeated Segment Finder dialog is called the “Highlight repeated segments.” In one embodiment of the present invention, if this options is selected, the UI Processor 140 uses the API provided by the FMA's manufacturer to highlight each instance of the repeated data segment in the File 110.

In one embodiment, the highlighting can be implemented by modifying the formatting of the text within the File 110 itself, using the APIs provided by the FMA's manufacturer. In another embodiment the highlighting can be implemented just in the user interface and do not modify the contents of the file.

In another embodiment of the present invention, the highlighting information can be recorded in the Search Results database 130. For example, the database may include the formatting table that identifies each repeated segment by the id and associates this repeated segment with the type of the formatting selected by the user.

Another option that may appear in the Repeated Segment Finder dialog is called the “Replace repeated segments.” If this option is selected, in one embodiment of the present invention, the UI Processor 140 will use the API provided by the FMA's manufacturer to replaces every repeated instance of the segment with a predefined identifier.

For examples, the predefined identifier can be hard-coded or it can be configurable the user. One example of the predefined identified can be a numeric ID of the segment. In another example, the repeated data segment can be replaced with an icon.

In one embodiment, if the repeated data segment was replaced with an icon and the user clicks on the icon, the “click event” information can be delivered to the UI Processor 140, which, in one embodiment will replace the icon with the repeated data segment.

Another option that may appear in the Repeated Segment Finder dialog is called “Select repeated segments.” This option can be useful if the user wants to identify and automatically select the repeated data segments. Selected data segments, for example, can be easily copied and moved to a different document. Selected data segments can also be easily removed from the body of the document.

Another option that may appear in the Repeated Segment Finder dialog is called “Ignore repeated segments.” This option can be helpful if the user wants to undo the user interface changes made to the repeated data segments.

For example, if the “highlight repeated data segments” option was used during the previous search for the repeated data segments, the repeated data segments may appear highlighted. If the user wants to undo this change, in one embodiment, this can be done by using the “Ignore repeated segments” option.

Another option that may appear in the Repeated Segment Finder dialog is called the “Search in the current document only.” This option tells the search engine that the user is only interested in the repeated segments located within the body of the currently viewed document.

Another option that may appear in the Repeated Segment Finder dialog is called the “Search in all open documents.” This option tells the search engine that the user is interested in the repeated segments located within the body of all open documents.

This option can be useful, for example, in some financial application, where the information describing a company may repeat in multiple documents. In that case, the search engine of the present invention will identify the repeated company information within multiple these documents.

Another option that may appear in the Repeated Segment Finder dialog is called the “Search in all selected documents.” This option tells the search engine that the user is only interested in the repeated segments located within the body of the specified documents. This option may be useful if the repeated segments may appear within multiple files.

Another option that may appear in the Repeated Segment Finder dialog is called the “Link repeated segments.” This option provides advanced ways of modifying the information within the repeated segments.

For example, if the “Link repeated segments” is selected, in one embodiment, the UI Processor 140 will receive the change and update events from the FMA 100. The UI Processor will monitor each event to ensure that the user is not changing the contents of the repeated data segments.

In one embodiment, if the UI Processor 140 detects that a user is changing the contents of the repeated data segments. This functionality can be implemented, for example, by registering for the notification events generated whenever the document is updated. After receiving the update notification, the UI Processor 140 can use the API provided by the FMA 100 to update all other instances of the modified repeated data segment.

Other embodiments are within the scope and spirit of the invention. For example, due to the mature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A repeated segment manager comprising:
a search engine for automatically identifying repeated data segments; a search results database for storing information describing the repeated data segments; and a UI processor for delivering the information describing the repeated data segments to a user.

2. The repeated segment manager of claim 1, wherein the search engine is receiving an instruction from a file management application to identify the repeated data segments.

3. The repeated segment manager of claim 1, wherein the UI processor delivers the repeated data segment information to the user by highlighting the repeated data segments.

4. The repeated segment manager of claim 1, wherein the search engine is using a preprocessing search algorithm for identifying the repeated data segments.

5. The repeated segment manager of claim 1, wherein the search engine is identifying the repeated data segments only if a length of the repeated data segments is greater than a minimum threshold.

6. The repeated segment manager of claim 1, wherein the search engine is searching for the repeated data segments within a search scope identified by the user.

7. The repeated segment manager of claim 5, wherein the search engine is identifying a plurality of all possible continuous data segments of the length equal to the minimum threshold.

8. The repeated segment manager of claim 5, wherein the search engine is determining a true length of the repeated data segments by comparing information before a starting point and after the ending point of the repeated data segments.

9. The repeated segment manager of claim 1, wherein the repeated data segments comprise inconsistencies up to the level provided by an error threshold parameter.

10. The repeated segment manager of claim 1, wherein the information stored in the search results database comprises at least one of the repeated data segment id, location of the repeated data segment within a file, length of the repeated data segment.

11. The repeated segment manager of claim 1, wherein the information stored in he search results database comprises at least one of the ID of the delta, location of the delta, length of the delta.

12. The repeated segment manager of claim 1, wherein the search engine is comparing media objects located within data segments by comparing the metadata information describing the objects.

13. The repeated segment manager of claim 1, wherein the search engine is comparing media objects located within data segments by invoking the external application designed to compare the media objects.

14. The repeated segment manager of claim 1, wherein the UI Processor delivers the information to the user according to preferences selected in a configuration dialog.

15. The repeated segment manager of claim 1, wherein the search results database records the information describing the repeated data segments on the persistent storage.

16. The repeated segment manager of claim 1, wherein the user has an option to link the repeated data segments, such that all modifications made to one instance of the repeated data segment will be automatically made to all other instances of this segment.
